(19) United States
(12) Patent Application Publication
(10) Pub. No.: US 2009/0168770 A1
(43) Pub. Date: Jul. 2, 2009

(54) TECHNIQUES FOR EFFICIENT TRANSFER OF MEDIUM ACCESS CONTROL STRUCTURES IN A COMMUNICATION SYSTEM

(76) Inventor: Shantidev Mohanty, Santa Clara, CA (US)

Correspondence Address: KACVINSKY LLC;C/O INTELLEVATE, P.O. BOX 52050, MINNEAPOLIS, MN, 55402, US

(21) Appl. No.: 11/966,084

(22) Filed: Dec. 28, 2007

(51) Int. Cl. H04L 12/56

(52) U.S. Cl. 370/389

(57) ABSTRACT

Techniques for efficient transfer of media access control (MAC) structures in a wireless communication system are described. An apparatus may comprise a MAC controller comprising one or more components operative to establish a unidirectional logical link between a base station and a mobile station in either a downlink or uplink direction. The MAC controller may include a service data unit (SDU) scheduler operative to schedule SDUs from different connection queues for communication by a single MAC PDU for a single downlink burst or single uplink burst of a communication frame in the respective downlink or uplink directions. Other embodiments are described and claimed.

### BACKGROUND

Mobile Worldwide Interoperability for Microwave Access (WiMAX) is a broadband wireless technology for fixed and mobile broadband networks to enable broadband data services including data, streaming video, and voice etc. Mobile WiMAX systems may operate in accordance with standards such as the Institute for Electronic and Electrical Engineers (IEEE) 802.16e-2005 standard, “Air Interface for Fixed and Mobile Broadband Wireless Access Systems,” (February, 2005) and the evolving IEEE 802.16m standard, “Advanced Air Interface.”

The medium access control (MAC) layer of IEEE 802.16e-2005 was originally inherited from Data Over Cable Service Interface Specification (DOCSIS) standard. For IEEE 802.16e-2005 and mobile WiMAX, each MAC Protocol Data Unit (PDU) typically includes a Generic MAC header (GMH) followed by a payload that includes one or more Service Data Units (SDUs). As defined in IEEE 802.16e-2005, the size of the GMH is 6 octets: Header Type (HT) (1 bit), Encryption Control (EC) (1 bit), Payload Type (6 bits), Reserved (Rsv) (1 bit), CRC indicator (C1) (1 bit), Encryption Key Sequence (EKS) (2 bits), Rsv (1 bit), Payload Length most significant bits (LEN MSB) (3 bits), Payload Length least significant bits (LEN LSB) (8 bits), Connection Identifier most significant bits (CID MSB) (8 bits), Connection Identifier least significant bits (CID LSB) (8 bits), and Header Check Sequence (HCS) (8 bits).

The size of a GMH and other MAC headers represent significant overhead for a MAC packet data unit (PDU). Each MAC PDU provides transport service for a particular connection between a base station (BS) and a mobile station (MS). The emergence of increased demand for wireless devices with multiple applications, however, typically increases the number of active connections between a BS and MS. For example, a wireless device may establish a voice connection to participate in a telephone call, and at the same time establish a data connection to browse the Internet. The presence of such simultaneous active connections requires more SDUs and MAC PDUs to service the connections, which increases the number of GMHs and other MAC headers needed for the corresponding MAC PDUs. The increase in GMHs and other MAC headers increases the overhead for the transport channels, thereby decreasing traffic throughput and efficiency.

### BRIEF DESCRIPTION OF THE DRAWINGS

FIG. 1 illustrates one embodiment of a packet data structure.

FIG. 2 illustrates one embodiment of a controller.

FIG. 3 illustrates one embodiment of a communication system.

FIG. 4 illustrates one embodiment of a logic flow.

FIG. 5 illustrates one embodiment of an article of manufacture.

### DETAILED DESCRIPTION

Various embodiments are generally directed to wireless communications systems. Some embodiments are particularly directed to techniques for the efficient transfer of MAC Service Data Units (SDUs) in a wireless communication system. In one embodiment, for example, an apparatus may comprise a MAC controller comprising one or more components operative to establish a unidirectional logical link between a BS and a subscriber station in either a downlink or uplink direction. The MAC controller may further include a SDU scheduler operative to schedule SDUs from different connection queues for communication by a single MAC PDU for a single downlink burst or single uplink burst of a communication frame in the respective downlink or uplink directions. Other embodiments are described and claimed.

More particularly, various embodiments are directed to a packet data structure such as a MAC PDU. The MAC PDU may comprise a generic data unit and one or more connection specific data units capable of significantly reducing MAC header overhead for MAC PDU. The use of a generic data unit and one or more connection specific data units by a MAC PDU allows different SDUs from different connections to be present within the MAC PDU. This may reduce the number of MAC PDUs communicated within a wireless communication system, and the corresponding overhead of GMH and other MAC headers carried by the MAC PDUs.

In various implementations, the packet data structure may be used in mobile WiMAX systems designed to operate in accordance with the IEEE 802.16e-2005 standard and/or the evolving IEEE 802.16m standard. It can be appreciated that while exemplary embodiments may be described in the context of mobile WiMAX systems and/or the IEEE 802.16e-2005 and IEEE 802.16m standards for purposes of illustration, the aspects and advantages described herein may be applicable to improve other wireless communications systems and standards in accordance with the described embodiments. For example, some embodiments may be compatible with devices and/or networks operating in accordance with existing IEEE 802.11, 802.11a, 802.11b, 802.11e, 802.11g, 802.11h, 802.11i, 802.11n, 802.16, 802.16d, 802.16e, 3GPP Long Term Evolution (LTE) standards as well as future versions, derivatives, or evolution of the above standards.

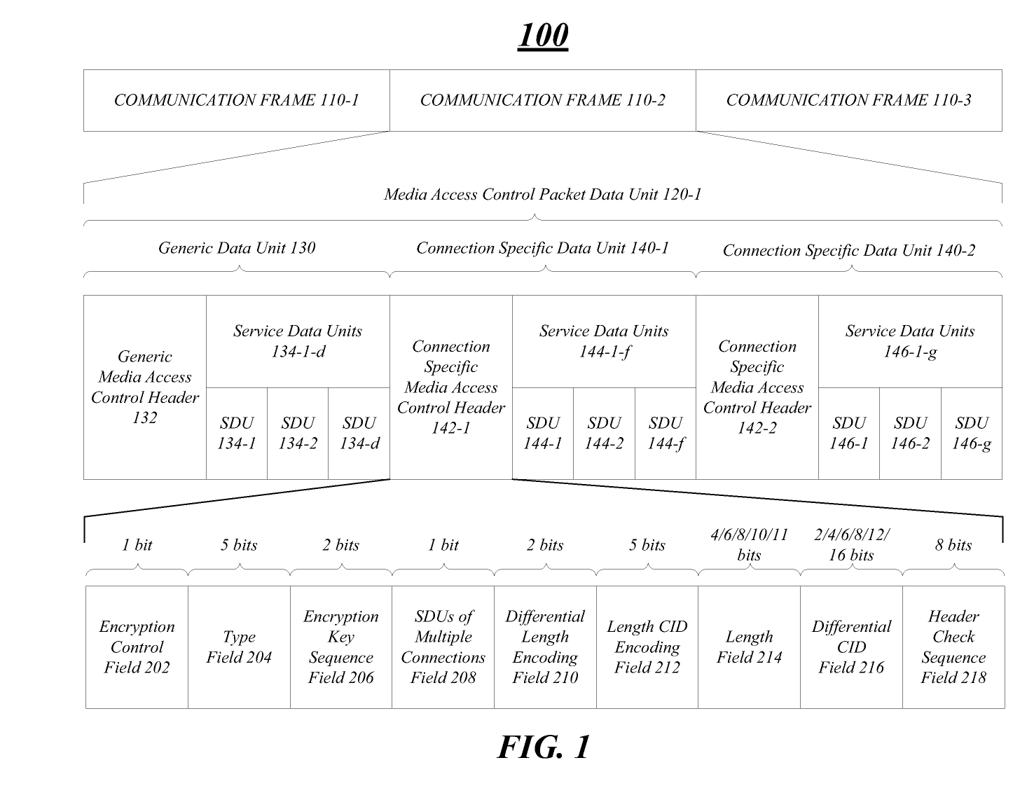

FIG. 1 illustrates one embodiment of a packet data structure 100. As shown, the packet data structure 100 may comprise multiple communication frames 110-1-a. The communication frames 110-1-a may comprise, for example, Orthogonal Frequency Division Multiple Access (OFDMA) communication frames used by a WiMAX system. The embodiments, however, are not limited to this example.

Each of the communication frames 110-1-a may be used to communicate one or more MAC PDUs 120-1-b. A representative communication frame 110-2 includes an example of a MAC PDU 120-1. The MAC PDU 120-1 may include several portions, including a generic data unit 130 and one or more connection specific data units 140-1-c.

The packet data structure illustrated by the MAC PDU 120-1 may solve various problems with conventional communication systems, particularly WiMAX systems. For example, one of the functionalities of the MAC layer is to create MAC PDUs. The MAC layer receives higher layer SDUs from a network protocol stack, and classifies them to different transport connections based on different criteria such as quality-of-service (QoS) support. In addition, the MAC layer may create its own messages such as management messages belonging to different management connections. The MAC layer of a sending node (e.g., a BS) needs to send these multiple SDUs from various layers of the network protocol stack and the management messages to a receiving node (e.g., a MS). Consequently, the MAC layer of the sending node has the task of sending MAC SDUs of different transport and management connections to the MAC layer of the receiving node. In the current IEEE 802.16 standards, however, a MAC PDU only contains SDUs that belong to a single MAC connection. Accordingly, when the sending node has to send MAC SDUs belonging to different MAC connections, it has to create separate MAC PDUs, one for the MAC SDUs of each MAC connection. This results in the communication of an unnecessary number of MAC PDUs, each contributing a significant amount of overhead in the form of various GMH and other MAC headers typically found in a MAC PDU.

To solve these and other problems, various embodiments may implement techniques to schedule SDUs from different connection queues for communication by a single MAC PDU, such as the MAC PDU 120-1. In this manner, a single MAC PDU may be used to communicate SDUs for different transport and management connections, thereby reducing an overall number of MAC PDUs communicated by a WiMAX system, as well as the corresponding amount of overhead associated with each MAC PDU. This may result in efficient utilization of communication and computing resources for a wireless communication system in general, and a wireless device in particular.

Referring to the illustrated embodiment shown in FIG. 1, the MAC PDU 120-1 may include the generic data unit 130 and one or more connection specific data units 140-1-c. The data units 130, 140 may be used to identify a given transport or management connection between a BS and a MS. When established, a connection may comprise a unidirectional logical link between the BS and the MS in either the downlink (DL) or uplink (UL) direction. In various implementations, DL and UL connections may comprise, for example, transport connections for the transmission of user data traffic flows and management connections for the transmission of MAC control and/or signaling data.

Some embodiments may classify or schedule SDUs from different connections for communication by a single MAC PDU that is for a single downlink DL burst in a communication frame, or a single MAC PDU that is for a single UL burst of a communication frame. As used herein, the term DL burst refers to some or all of a DL frame or sub-frame for a communications system that uses the same modulation, error correcting code, or other common criteria in a DL direction. Similarly, the term UL burst refers to some or all of a UL frame or sub-frame for a communications system that uses the same modulation, error correcting code or other common criteria in an UL direction. It may be appreciated that the actual definition of a DL burst and an UL burst may vary from one standard to another. The various embodiments may remain relevant, however, as long as the MAC PDUs or data for MSs are located in a specific region or in the entire DL/UL sub-frame of a communication system. The embodiments are not limited in this context.

The generic data unit 130 may include a GMH 132. In one embodiment, for example, the GMH 132 may comprise a GMH as defined by IEEE 802.16e-2005 modified to include a SDUs of Multiple Connections (SMC) value. In one embodiment, for example, the SMC value may be implemented by the GMH 132 using the 1-bit reservation field as defined by the IEEE 802.16e-2005. The reservation field of the GMH 132 may be used as a SMC field that includes a SMC value indicating SDUs for multiple MAC connections are present or absent in the MAC PDU 120-1. For example, when the SMC value is set to a logical zero (SMC=0) the SMC value indicates that SDUs for multiple MAC connections are absent in the MAC PDU 120-1, or stated another way, the SMC value of 0 indicates that the MAC SDUs of only one MAC connection are present in the MAC PDU 120-1. In another example, when the SMC value is set to a logical one (SMC=1) the SMC value indicates that SDUs for multiple MAC connections are present in the MAC PDU 120-1. The meanings set for the SMC values may be reversed as desired for a given implementation.

In addition to the GMH 132, the generic data unit 130 may further include one or more SDUs 134-1-d appended to the GMH 132. The SDUs 134-1-d may represent SDUs for a single connection as identified by a Connection Identifier (CID). In one embodiment, for example, the SDUs 134-1-d may represent SDUs for a single connection having a CID with a lowest assigned value for the different connections present for the MAC PDU 120-1, referred to herein as CID1.

Although not shown in FIG. 1, the generic data unit 130 may also include various sub-headers and extended sub-headers as defined by the various IEEE 802-16 standards. For example, when a SDU 134-1-d represents a fragment of an SDU, then a fragmentation sub-header may be present in the generic data unit 130. Such sub-headers and extended sub-headers may be added to the generic data unit 130 as needed for a given implementation.

The MAC PDU 120-1 may include one or more connection specific data units 140-1-c appended to the generic data unit 130. Each connection specific data unit 140-1-c may include a connection specific MAC header (CMH) 142-1-e and one or more SDUs for a given connection. For example, the connection specific data unit 140-1 may include a CMH 142-1 and one or more SDUs 144-1-f for a connection CID2, the connection specific data unit 140-2 may include a CMH 142-2 and one or more SDUs 146-1-g for a connection CID3, and so forth.

In the illustrated embodiment shown in FIG. 1, the MAC PDU 120-1 includes SDUs 134, 144, 146 for respective connections CID1, CID2, CID3. The particular number of connection specific data units 140-1-c for a given implementation of a MAC PDU 120-1-b, however, may vary in accordance with a number of different connections for the MAC PDU 120-1-b, a size of a given MAC PDU 120-1-b, a size of a given communication frame 110-1-a, traffic conditions, channel characteristics, and so forth.

A receiving node may parse the MAC PDU 120-1 to retrieve the SDUs 134, 144, 146 for the respective connections CID1, CID2, CID3 using the GMH 132 and the CMH 142-1-e. In various embodiments, the CMH 142-1-e may include connection information independent from the information provided by the GMH 132, connection information that is derived or dependent on the information provided by the GMH 132, or a combination of both. The representative CMH 142-1 may comprise multiple fields and values, some of which are derived or dependent on the information provided by the GMH 132. This differential encoding technique may reduce the amount of connection information needed for the CMH 142-1, and therefore reduce the overhead for the MAC PDU 120-1. Other encoding techniques, however, may also be used as long as they are known by the sending and receiving nodes.

The CMH 142-1 shown in FIG. 1 comprises nine different fields, including an encryption control (EC) field 202, a type field 204, an encryption key sequence (EKS) field 206, a SDUs of multiple connections (SMC) 208, a differential length encoding (DLE) field 210, a length CID encoding (LCE) field 212, a length (LEN) field 214, a differential CID (DCID) field 216, and a header check sequence (HCS) field 218. Some of the fields used by the CMH 142-1 may be the same or similar to fields defined by IEEE 802.16 standards. For example, the CMH 142-1 may implement the EC field 202, the EKS field 206, and the HCS field 218 using the same definitions and meanings as provided by IEEE 802.16e-2005. The remaining fields used by the CMH 142-1, however, may be novel fields useful in describing the various SDUs 144, 146. It may be appreciated that the CMH 142-1 may omit or combine some of the nine fields to form a lesser number of fields, or add other fields to form a greater number of fields, as desired for a given implementation of a CMH.

The CMH 142-1 may include a type field 204 comprising 5 bits. The type field 204 may be similar to the type field encoding of the GMH 132 as specified in IEEE 802.16e-2005, except for the absence of mesh sub-header. The mesh sub-header, if needed, can be specified using the type field of the GMH 132. Consequently, there is no need to specify a mesh sub-header in the CMH 142-1. An example of the values suitable for use with the type field 204 may be shown in Table 1 as follows:

TABLE 1

| Type bit | Value |
|---|---|
| #4 | ARQ feedback payload |
| most significant bit (MSB) | 1 = present, 0 = absent |
| #3 | Extended type |
| | Indicates whether the present Packing or |
| | Fragmentation sub-header is Extended. |
| | 1 = Extended, 0 = not Extended |
| #2 | Fragmentation sub-header |
| | 1 = present, 0 = absent |
| #1 | Packing sub-header |
| | 1 = present, 0 = absent |
| #0 | Downlink: FAST-FEEDBACK |
| Least significant bit (LSB) | Allocation sub-header |
| | Uplink: Grant Management sub-header |
| | 1 = present, 0 = absent |

The CMH 142-1 may include a SMC field 208 comprising 1 bit. The SMC field 208 may be similar to the SMC field used by the GMH 132. The SMC field 208 may have a SMC value indicating one or more SDUs for a subsequent connection follows one or more SDUs for a current connection. The current connection may refer to the SDUs immediately following the CMH 142-1, while the subsequent connection may refer to the SDUs following the CMH 142-2. For example, the SMC field 208 of the CMH 142-1 may have a SMC value indicating one or more SDUs 146-1-g for a subsequent connection CID3 follows one or more SDUs 144-1-f for a current connection CID2. The SMC value may be set to a logical one (SMC=1) when the MAC PDU 120-1 has one or more additional connection specific data units 140-2-c with additional SDUs for other connections, and to a logical zero (SMC=0) when the MAC PDU 120-1 does not have additional connection specific data units 140-2-c, or vice-versa. In the illustrated embodiment shown in FIG. 1, the SMC field 208 for the CMH 142-1 would be set to logical one (SMC=1) due to the presence of the connection specific data unit 140-2, and the SMC field 208 for the CMH 142-2 would be set to logical zero (SMC=0) due to the absence of any more connection specific data units 140-3-c following the connection specific data unit 140-2.

The CMH 142-1 may include a DLE field 210 comprising 2 bits. The DLE field 210 may include a DLE value indicating whether a LEN value for the LEN field 214 of the CMH 142-1 represents an actual length or an offset value for a LEN value of a LEN field of the GMH 132. For example, assume the LEN value for the GMH 132 is represented as L1, and the LEN value for the CMH 142-1 is represented as L2. The LEN value L2 may represent a length for the SDUs 144-1-f as well as any sub-headers for the MAC connection CID2. A receiving node may derive L2 using the 2-bit DLE value as shown in Table 2 as follows:

TABLE 2

| DLE Value | L2 |
|---|---|
| 00 | L2 = X |
| 01 | L2 = L1 + X |
| 10 | L2 = L1 − X |
| 11 | Reserved |

The value X may represent the value of the LEN field 214 of the CMH 142-1. The use of differential encoding for the LEN field 214 of the CMH 142-1 reduces the number of bits required to specify the length. Thus, it reduces the MAC layer overhead associated with the CMH 142-1.

The CMH 142-1 may include a DCID field 216 comprising multiple bit sizes. The DCID field 216 may include a DCID value representing a difference between a CID for a current connection and a CID for a preceding connection. The current connection may refer to the connection for the SDUs following the CMH 142-1, while the preceding connection may refer to the connection for the SDUs following the GMH 132. For example, the DCID field 216 may have a DCID value indicating a difference between the current connection CID2 for the SDUs 144-1-f and the preceding connection CID1 for the SDUs 134-1-d. As previously described, the SDUs 134-1-d packed for the generic data unit 130 should be for the lowest MAC connection of the MAC PDU 120-1, as represented by CID1. Since the DCID value represents the difference between CID1 and CID2, the absolute value of CID2 can be determined. The use of a differential CID technique reduces the number of bits required to specify CID2. Thus, it reduces the MAC layer overhead associated with the CMH 142-1. It may be appreciated that a CID for a current connection and a CID for a preceding connection may vary depending upon which CMH 142-1-e is being processed. For example, if the CMH 142-2 is being processed, then the DCID field 216 may have a DCID value indicating a difference between the current connection CID3 for the SDUs 146-1-g, and the preceding connection CID2 for the SDUs 144-1-f.

The CMH 142-1 may include a LCE field 212 comprising 5 bits. The LCE field 212 may include a LCE value indicating a number of bits used to encode a LEN value for the LEN field 214 and a DCID value for the DCID field 216 of the CMH 142-1. The length of the LEN field 214 and the DCID field 216 may vary depending on the actual value of L2 and CID2 in this illustration. In this illustration, the length of the LEN field 214 may comprise one of the following five values: 4 bits, 6 bits, 8 bits, 10 bits, and 11 bits. Similarly, the length of the DCID field 216 may comprise one of the following six values: 2 bits, 4 bits, 6 bits, 8 bits, 12 bits, and 16 bits. Thus, the total number of possible combinations for the length of the LEN field 214 and the DCID field 216 is 30. Differential encoding of the LCE field 212 indicates a particular combination of length of the LEN field 214 and the DCID field 216 of the CMH 142-1. It may be noted that using 5 bits the LCE field 212 can specify 32 different combinations, and therefore 5 bits is sufficient to represent the 30 possible combinations for the LEN field 214 and the DCID field 216. It may be noted that other possible length values for the LEN field 214 and the DCID field 216 can be selected. In fact different number of bits for the LCE field 212 could be used if necessary. The embodiments are not limited in this context.

It is worthy to note that in the above example the LEN field 214 (when DLE=01 or DLE=10) and the DCID field 216 of the CMH 142-1 are specified as an offset value with respect to the LEN field and the CID field of the GMH 132. In other implementations, the LEN field 214 and the DCID field 216 of the CMH 142-1 can be specified as an offset value with respect to the LEN field 214 and the DCID field of a preceding CMH in cases where there are more than one CMH 142-1-e in the MAC PDU 120-1. The embodiments are not limited in this context.

In various implementations, the MAC PDU 120-1 may be transmitted over a mobile WiMAX air interface between a BS and a MS. For example, the mobile WiMAX air interface may support OFDMA techniques, and the MAC PDU 120-1 may be transported within an OFDMA frame 110-2. It can be appreciated that the MAC PDU 120-1 imposes slightly additional complexity on the mobile WiMAX air-interface including BS and MS implementations, although at the benefit of potentially reducing the overall number of MAC PDUs 120-1-b communicated between a BS and MSs in a WiMAX system.

OFDMA techniques may involve multiplexing operations for subdividing bandwidth into multiple frequency subcarriers. OFDMA techniques may improve multi-path performance by coding and interleaving information across subcarriers prior to transmission. When implemented by an OFDMA frame, the MAC PDU 120-1 may be included in a DL subframe or a UL subframe. For example, an OFDMA frame for TDD (Time Division Duplex) operation may comprise DL and UL sub-frames, and the MAC PDU 120-1 may be included in a DL burst within the DL subframe or in a UL burst within a UL subframe.

In addition to the MAC PDU 120-1, an OFDMA frame may comprise various control information such as a preamble used for synchronization, a Frame Control Header (FCH) used for frame configuration information (e.g., burst profile, burst length), an uplink media access protocol MAP (UL-MAP) to indicate UL usage, a downlink MAP (DL-MAP) to indicate DL usage, a UL ranging channel used for ranging, and a UL bandwidth request channel for bandwidth requests, a UL Channel Quality Indicator Channel (CQICH) for reporting channel state information, and a UL Acknowledge (ACK) channel for Hybrid Automatic Repeat Request (HARQ) ACK/NACK signaling.

It can be appreciated that the described embodiments may be implemented by the MAC layer of a wireless device designed to operate in accordance with the IEEE 802.16e-2005 standard and/or the evolving IEEE 802.16m standard. For example, the MAC layer of a BS or MS may implement aspects of the described embodiments as part of DL and/or UL packet creation in order to significantly decrease the number of MAC PDUs 120-1-b communicated in the WiMAX system.

It also can be appreciated that it various techniques may be implemented to distinguish use of the generic data unit 130 and connection specific data units 140-1-c of the MAC PDUs 120-1-b from conventional MAC headers (e.g., GMH and BW-REQ header) so that the described embodiments are compatible with legacy devices and/or networks operating in accordance with existing IEEE standards such as IEEE 802.16e-2005, as well as with devices and/or networks operating in accordance with future versions, derivatives, or the evolution of the above standards (e.g., IEEE 802.16m).

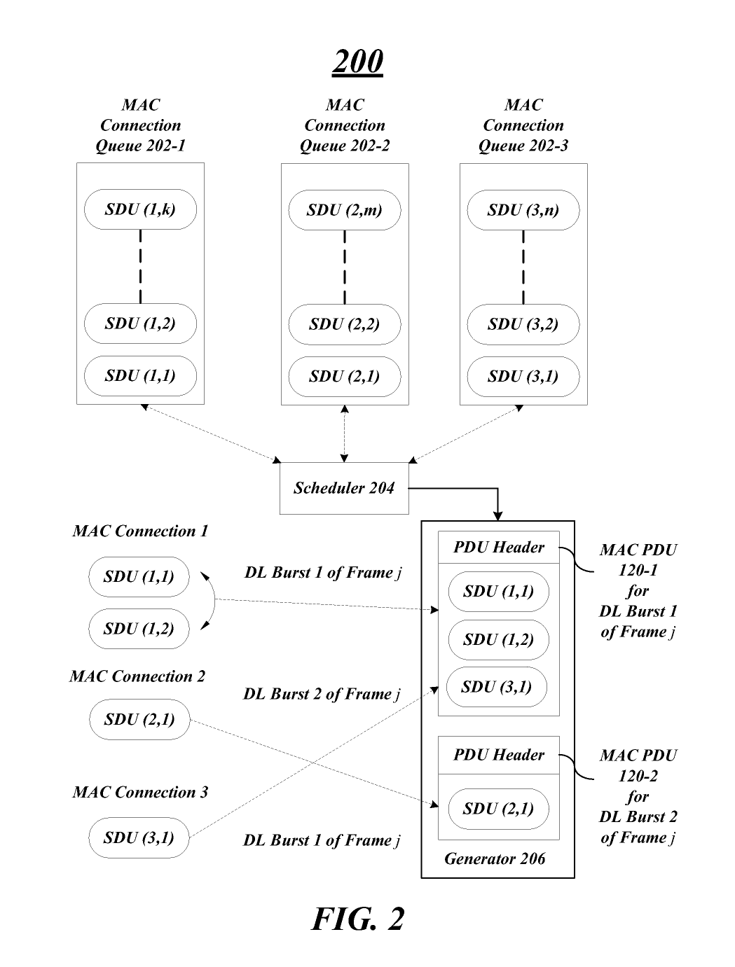

FIG. 2 illustrates one embodiment of a controller 200. The controller 200 may represent, for example, a MAC controller 200 arranged to implement logic for various MAC layer operations to generate one or more of the MAC PDUs 120-1-b. The controller 200 may be implemented by a wireless device, such as a BS or a MS. It may be appreciated that other computing and communications elements common to electronic devices may be implemented by a wireless device implementing the controller 200. For example, a wireless device implementing the controller 200 may further include various computing resources or elements as appropriate for a given implementation, such as a processor, memory, chipsets, controllers, peripherals, input devices, output devices, and so forth. In another example, a wireless device implementing the controller 200 may further include various communications resources or elements as appropriate for a given implementation, such as baseband processors, filters, amplifiers, modulators, demodulators, multiplexers, mixers, switches and so forth. The embodiments are not limited in this context.

The controller 200 may be arranged to create the MAC PDUs 120-1-b for a wireless device such as a BS or MS of a WiMAX system. The MAC PDUs 120-1-b are communicated in the DL direction from a BS to a MS in one or more DL bursts in the DL sub-frame. Similarly, the MAC PDUs 120-1-b are communicated in the UL direction from a MS to a BS using one or more UL bursts in the UL sub-frame. It may be noted that one DL sub-frame and one UL sub-frame typically comprise a single frame in these standards.

The illustrated embodiment shown in FIG. 2 shows some of the MAC layer operations performed by the controller 200 when a WiMAX compliant BS creates MAC PDUs 120-1, 120-2 for a particular WiMAX compliant MS of a WiMAX system to be transmitted in a DL sub-frame. It may be appreciated that only a relevant subset of the operations involved in creating the MAC PDUs 120-1, 120-2 by the BS are shown in FIG. 2, and not the entire set of operations typically used to create a MAC PDU for a WiMAX system.

In the illustrated embodiment shown in FIG. 2, assume the controller 200 may service three MAC connections CID1, CID2, CID3 each having a corresponding MAC connection queues 202-1, 202-2, 202-3 in a memory unit. The MAC connection queues 202-1, 202-2, 202-3 may be used to store respective k, m, n number of SDUs 210 waiting in their respective queues to be transmitted in a DL sub-frame from a BS to a MS. For example, the MAC connection queue 202-1 may have multiple SDUs 210 for the connection CID1, as represented by SDU (1, 1), SDU (1, 2), SDU (1, k). The MAC connection queue 202-2 may have multiple SDUs 210 for the connection CID2, as represented by the SDU (2, 1), SDU (2, 2), SDU (2, m). The MAC connection queue 202-3 may have multiple SDUs 210 for the connection CID3, as represented by the SDU (3, 1), SDU (3, 2), SDU (3, n).

The controller 200 may include a SDU scheduler 204. The SDU scheduler 204 may be arranged to determine which MAC SDUs 210 of the different MAC connections for the MS are to be transmitted in the DL sub-frame. As shown in FIG. 2, the SDU scheduler 204 schedules SDU (1, 1), SDU (1, 2), SDU (3, 1) to be transmitted in DL Burst 1 of DL sub-frame of frame j, and SDU (2, 1) to be transmitted in the DL Burst 2 of DL sub-frame of frame j. Using this technique, a single MAC PDU 120-1 is created containing SDU (1, 1), SDU (1, 2), SDU (1, 3) since all these SDUs are to be transmitted in the same DL Burst 1 for the MS. Another MAC PDU 120-2 is created containing SDU (2, 1) to be transmitted in the DL Burst 2 for the same or different MS. As a result, the MAC PDU generator 206 only needs to generate the MAC PDUs 120-1, 120-2. By way of contrast, conventional IEEE 802.16 standards typically schedule all the SDUs for a given MAC connection to the same MAC PDU. In this case, the MAC PDU generator 206 would need to generate three MAC PDUs, thereby representing a 50% increase in MAC PDUs and a corresponding increase in PDU Header overhead.

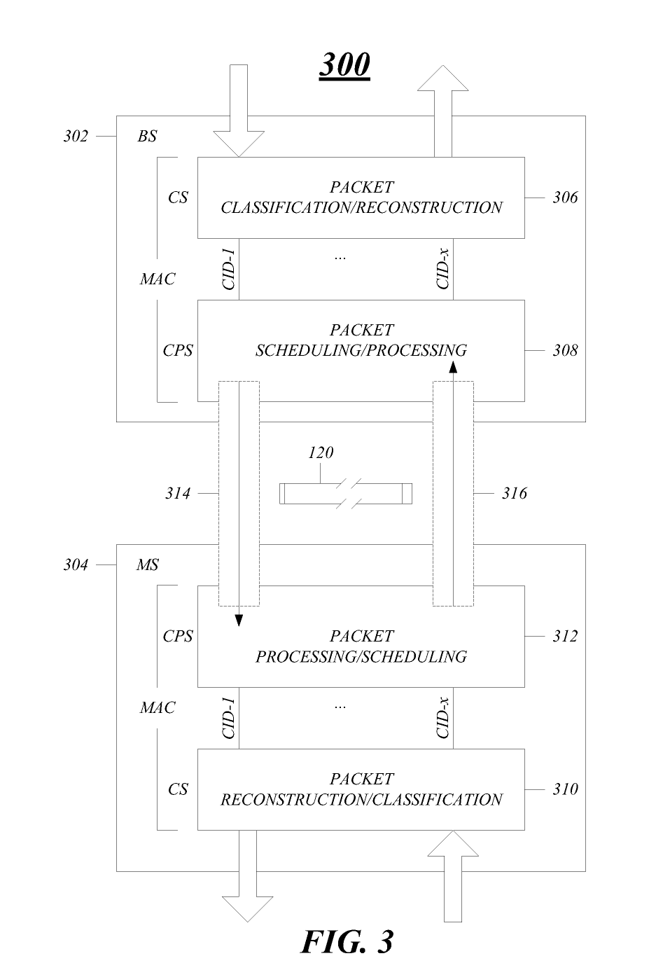

FIG. 3 illustrates one embodiment of a mobile WiMAX system 300. In various embodiments, mobile WiMAX system 300 may operate in accordance with the IEEE 802.16e-2005 standard and/or the evolving IEEE 802.16m standard. It can be appreciated that aspects and advantages described herein may be applicable to improve other wireless communications systems and standards.

Mobile WiMAX system 300 may support various communication and/or modulation techniques such as Frequency Division Multiplexing (FDM), Orthogonal FDM (OFDM), Orthogonal Frequency Division Multiple Access (OFDMA), Scalable OFDMA (S-OFDMA), Coded OFDM (COFDM), Time Division Multiplexing (TDM), Time Division Multiple Access (TDMA), Extended TDMA (E-TDMA), Time-Division Duplex (TDD), Frequency Division Duplex (FDD), Quadrature Phase Shift Keying (QPSK), Offset QPSK (OQPSK), Differential QPSK (DQPSK), Quadrature Amplitude Modulation (QAM), N-state QAM (N-QAM), Differential QAM (DQAM), and others.

Mobile WiMAX system 300 may employ various coding techniques such as CRC, Forward Error Correction (FEC), Automatic Repeat Request (ARQ), Hybrid ARQ (HARQ), Fast Channel Feedback, Convolution Code (CC), Convolution Turbo Code (CTC), Block Turbo Code, Low Density Parity Code Check (LDPC), and others.

Mobile WiMAX system 300 may support various encryption techniques such as Advanced Encryption Standard (AES) encryption, Advanced Access Content System (AACS) encryption, Data Encryption Standard (DES) encryption, Triple DES (3DES) encryption, Rivest, Shamir, and Adleman (RSA) encryption, Elliptic curve cryptography (ECC) encryption, and others.

Mobile WiMAX system 300 may utilize various antenna techniques such as Multiple Input Multiple Output (MIMO), Adaptive MIMO (A-MIMO), Single Input Multiple Output (SIMO), Multiple Input Single Output (MISO), Adaptive or Advanced Antenna System (AAS), and/or other intelligent or multiple antenna technology.

Mobile WiMAX system 300 may provide voice, video, audio, and/or data communications functionality in accordance with different types of systems such as Code Division Multiple Access (CDMA) systems, Global System for Mobile Communication (GSM) systems, North American Digital Cellular (NADC) systems, OFDMA systems, TDMA systems, E-TDMA systems, Narrowband Advanced Mobile Phone Service (NAMPS) systems, 3G systems such as Wide-band CDMA (WCDMA), CDMA-2000, and Universal Mobile Telephone System (UMTS) systems, GSM with GPRS systems (GSM/GPRS), CDMA/1xRTT systems, Enhanced Data Rates for Global Evolution (EDGE) systems, EV-DO systems, Evolution For Data and Voice (EV-DV) systems, High Speed Downlink Packet Access (HSDPA) systems, High Speed Uplink Packet Access (HSUPA) systems, Multi-Carrier Modulation (MDM) systems, Discrete Multi-Tone (DMT) system, Bluetooth (RTM) system, ZigBee (TM) system, and others.

Mobile WiMAX system 300 may communicate, manage, or process information in accordance with one or more protocols such as MAC protocol, Physical Layer (PHY) protocol, Physical Layer Convergence Protocol (PLCP), Dynamic Host Configuration Protocol (DHCP), File Transfer Protocol (FTP), Trivial FTP (TFTP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), Multipurpose Internet Mail Extensions (MIME) protocol, Gateway Control Protocol, Media Gateway Control Protocol (MGCP), Simple Gateway Control Protocol (SGCP), Session Announcement Protocol (SAP), Session Description Protocol (SDP), Session Initiation Protocol (SIP), Remote Voice Protocol (RVP), RVP Control Protocol (RVPCP), Real Time Streaming Protocol (RTSP), Real-time Transport Protocol (RTP), Synchronized Multimedia Integration Language (SMIL) protocol, Internet Streaming Media Alliance (ISMA) protocol, and others.

As shown, mobile WiMAX system 300 may comprise a BS 302 coupled to a MS 304 (sometimes referred to as a subscriber station). The BS 302 and the MS 304 may be implemented as hardware, software, or any combination thereof, as desired for a given set of design parameters or performance constraints. BS 302 may comprise or be implemented as a wireless device or system such as a WiMAX BS, relay station (RS), mobile multihop relay BS (MMR-BS), network hub, gateway, router, and so forth. MS 304 may comprise or be implemented as wireless device or system such as a wireless client device, user terminal, laptop computer, portable computer, personal computer (PC), notebook PC, handheld computer, server computer, personal digital assistant (PDA), cellular telephone, combination cellular telephone/PDA, VoIP telephone, smart phone, pager, messaging device, media player, digital music player, game device, set-top box (STB), appliance, customer premises equipment (CPE), wireless access point (AP), a modem, Global Positioning System (GPS) device, Location Based Services (LBS) device, navigation system, and others.

In general, a wireless device may comprise one or more wireless interfaces and/or components for wireless communication such as one or more transmitters, receivers, transceivers, chipsets, amplifiers, filters, control logic, network interface cards (NICs), antennas, and so forth. Examples of a transceiver may include a MIMO transceiver, SIMO transceiver, MISO transceiver, Multi Receiver Chain (MRC) transceiver, and so forth. Examples of an antenna may include an internal antenna, an external antenna, a monopole antenna, a meandered monopole antenna, a dipole antenna, a balanced antenna, a printed helical antenna, a chip antenna, a ceramic antenna, a planar inverted-F antenna (PIFA), a helical antenna, an end fed antenna, an omni-directional antenna, a circularly polarized antenna, a micro-strip antenna, a diversity antenna, a dual antenna, an antenna array, and others.

Although FIG. 3 may show a limited number of devices by way of example, it can be appreciated that mobile WiMAX system 300 may include additional devices or nodes for a given implementation. For example, WiMAX system 300 may include multiple BSs and several MSs. In addition, BS 302 may form part of an Access Service Network (ASN) and be coupled to an Access Service Network Gateway (ASN-GW). The ASN-GW may couple BS 302 to a Connectivity Service Network (CSN) comprising content services, support systems, routers, servers (e.g., application servers, AAA servers, DNS/DHCP servers), user databases, gateway devices, and other components. CSN may access other CSNs, Application Service Provider (ASP) networks, and/or the Internet. In some embodiments, MS 304 may form part of or connect to a network such as a Local Area Network (LAN), a Wireless LAN (WLAN), a Wireless Fidelity (WiFi) network, a Metropolitan Area Network (MAN), a Wireless MAN (WMAN), a Wide Area Network (WAN), a Wireless WAN (WWAN), a Personal Area Network (PAN), a Wireless PAN (WPAN), and so forth.

BS 302 and MS 304 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner.

The media and control information may be communicated from and to a number of different devices or networks. In various implementations, the media information and control information may be segmented into a series of packets. Each packet may comprise, for example, a discrete data set having a fixed or varying size represented in terms of bits, bytes, octets, and so forth. It can be appreciated that aspects of the described embodiments may be applicable to various types of communication content or format, such as frames, fragments, cells, windows, units, and others.

In various embodiments media and control information may be communicated over a wireless communication channel between BS 302 and MS 304. Examples of a wireless communication channel may include, without limitation, a radio channel, infrared channel, radio-frequency (RF) channel, a portion of the RF spectrum, and/or one or more licensed or license-free frequency bands. The wireless communication channel may be arranged to support one or more point-to-point connections between BS 302 and MS 304. Multiple connections may share resources (bandwidth, time, frequency, code, and space) of the physical wireless communication channel.

In order to establish a wireless communication channel for communicating information within mobile WiMAX system 300, BS 302 and MS 304 may perform various required operations such as DL synchronization, ranging, capabilities negotiation, authentication, registration, and IP connectivity operation to enable network access.

BS 302 may periodically transmit to serving sector(s) link description messages such as a DCD message to indicate characteristics of DL channel and a UCD message to indicate characteristics of UL channel. The UCD and DCD messages may contain burst profile information, modulation information, error-correction information, preamble length, and so forth.

MS 304 may scan for and detect DCD and UCD messages from BD 302 to obtain DL and UL parameters and to synchronize with the DL. MS 304 may receive an uplink media access protocol MAP (UL-MAP) message and a downlink MAP (DL-MAP) message from BS 302. The UL-MAP and DL-MAP may indicate usage of the UL and DL, respectively, and define control information such as burst start times and sub-channel allocation. The UL-MAP message may contain an Information Element (IE) indicating time slots in which MS 304 can transmit during the UL subframe. BS 302 may use scheduling techniques such as Uplink Bandwidth Allocation Scheduling to determine the UL-MAP, IE, and time slots.

MS 304 may send a ranging request message to BS 302. MS 304 may transmit the ranging request message using minimum transmission power. If BS 302 does not respond, MS 304 may send additional ranging request messages using higher transmission power until a ranging response is received from BS 302. The ranging response message from BS 302 may indicate success or required time, frequency, and/or power corrections. If corrections are required, MS 304 may make the required corrections and transmit another ranging request.

After successful ranging, MS 304 may report capabilities to BS 302 for negotiation. BS 302 may accept or deny access to the MS 304 based on such capabilities. MS 304 may send BS 302 a requested modulation and coding scheme (MCS) in the DL. The MCS may support Adaptive Modulation and Coding (AMC) having variable code rate and repetition rate. The MCS may include information such as baseband modulation (e.g., QPSK, 16QAM, 64QAM), type of FEC (e.g., CC, CTC), coding rate (e.g., ½, ⅔, ¾, ⅚), repetition rate (e.g., ×2, ×4, ×6), and so forth. MS 304 may send BS 302 a Channel Quality Indicator (CQI) report indicating channel conditions such as Physical Carrier to Interface plus Noise Ratio (CINR), Effective CINR, MIMO mode, selected sub-channel, and so forth.

After successful capability negotiation, BS 302 may authenticate MS 304 and provide necessary information (e.g., certificates, algorithms, protocols) to enable MS 304 to support encryption/decryption. MS 304 and BS 302 may exchange registration request and response messages. The registration may involve the exchange of various parameters such as IP version support, managed/non-managed support, ARQ support, classification support, CRC support, flow control, and others. MS 304 may obtain an IP address and other parameters to establish IP connectivity and download operational parameters.

To communicate within mobile WiMAX system 300, BS 302 and MS 304 may operate in accordance with various Quality of Service (QoS) levels and/or parameters. Examples of QoS levels may include unsolicited grant service (UGS), real-time polling service (rtPS), extended rtPS (ErtPS), non-real-time polling service (nrtPS), and best effort (BE) service flow. UGS may specify maximum sustained rate, maximum latency tolerance, and jitter tolerance for applications such as VoIP and interactive gaming. rtPS may specify minimum reserved rate, maximum sustained rate, maximum latency tolerance, and traffic priority for applications such as streaming audio and video. ErtPS may specify minimum reserved rate, maximum sustained rate, maximum latency tolerance, traffic priority and jitter tolerance for applications such as VoIP including voice with activity detection. nrtPS may specify minimum reserved rate, maximum sustained rate, and traffic priority for FTP applications. BE service flows may specify maximum sustained rate and traffic priority for applications such as e-mail, web browsing, and data transfer.

To support QoS and prior to any data transmission, the MAC layers of BS 302 and MS 304 may establish various types of connections. In various embodiments, the MAC layers of BS 302 and MS 304 may comprise several functional MAC layer components or modules. As shown in FIG. 3, for example, the MAC layer of BS 302 may comprise a MAC convergence sublayer (CS) component 306 and a MAC common part sublayer (CPS) component 308, and the MAC layer of MS 304 may comprise a MAC CS component 310 and a MAC CPS component 312. MAC CS components 306, 312 may be arranged to perform operations such as packet classification for outbound packets and packet reconstruction of inbound packets, as well as other operations in accordance with the described embodiments. MAC CPS components 308, 312 may be arranged to perform operations such as packet scheduling of outbound packets and packet processing of inbound packets, as well as other operations in accordance with the described embodiments.

It is to be appreciated that the described MAC layer components may be implemented by one or more chips or integrated circuits (ICs) and may comprise, for example, hardware and/or software such as logic (e.g., instructions, data, code, etc.) to be executed by a logic device (e.g., processor, core, controller, computer, etc.). Executable logic may be stored internally or externally to a logic device on one or more types of computer-readable storage media such as volatile or non-volatile memory, removable or non-removable memory, erasable or non-erasable memory, writeable or re-writeable memory, and so forth. It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

The connections provided by the MAC layers of BS 302 and MS 304 may support various types of transmission such as unicast transmission between a sender and a specified recipient (e.g., point-to-point), multicast transmission between a sender and multiple specified recipients (e.g., point-to-multipoint), broadcast transmission between a sender and all recipients within a coverage area, and others. The type of connection may be defined according to the type of data to be transmitted and/or direction of the data traffic flow.

When data is received at the MAC layer for transmission, outbound packets are associated with a service flow. The service flow may comprise a unidirectional flow of packets to be transmitted from BS 302 to MS 304 or vice versa. The service flow may be associated with a particular QoS and various parameters such as bandwidth, latency, jitter, and other QoS parameters. For a particular service flow, one or more connections are established between BS 302 and MS 304 for communicating packets. In general, a connection is set up when a data session begins between BS 302 and MS 304 and torn down after completion of the data session.

To create a connection, BS 302 and MS 304 may exchange various messages such as DSA messages. For some service flows, such as pre-provisioned service flows, connection creation may be initiated by BS 302. In such cases, BS 302 may send a DSA-REQ message to MS 304. MS 304 may confirm creation of the connection by sending a DSA-RSP message to BS 302. For other service flows, such as non-preprovisioned service flows, connection creation may be initiated by MS 304. In such cases, MS 304 may send a DSA-REQ message, and BS 302 may respond with a DSA-RSP message to confirm creation of the connection.

When established, each connection may comprise a unidirectional logical link between BS 302 and a MS 304 in either the DL or uplink UL direction. In various embodiments, DL and UL connections may comprise, for example, transport connections for the transmission of user data traffic flows and management connections for the transmission of MAC control and/or signaling data. As shown in FIG. 3, for example, DL connection 314 and UL connection 316 may be established between BS 302 and MS 304. It is to be appreciated that DL connection 314 and UL connection 316 are shown for purposes of illustration, and not limitation, and that a greater or fewer number of UL and DL connections may be established for a given implementation.

In various embodiments, one or more user connections established between BS 302 and MS 304 may be identified by a CID value. As shown in FIG. 3, for example, DL connection 314 may be identified by CID-1 and UL connection 316 may be identified by CID-x, where x may represent any positive integer value in accordance with the described embodiments. In this example, data packets to be transported over DL connection 314 from BS 302 to MS 304 may comprise any type of media information or control information. Examples of media information may include video data, Voice over Internet Protocol (VoIP) data, audio data, interactive gaming data, and so forth. When received at the MAC layer of BS 302, the data packets may be associated with a service flow, and classified by the MAC CS component 306 based on the CID-1.

After being associated with a service flow, data packets may be encapsulated within MAC PDU 120 and queued for transmission over DL connection 314. In various embodiments, MAC PDU 120 may be implemented by an OFDMA frame. For example, MAC PDU 120 may be included in a DL subframe of the OFDMA frame.

The MAC PDU 120 may comprise packet data structure 100 as described above with reference to FIG. 1. For example, the MAC PDU 120 may comprise a generic data unit 130 and one or more connection specific data units 140-1-c arranged to communicate SDUs for multiple connections within the single MAC PDU 120. This may reduce the number MAC PDUs communicated in the WiMAX system 300.

As described, packet data structure 100 may be used in both DL and UL directions. Accordingly, in some embodiments, the MAC PDU 120 may comprise connection information identifying SDUs for a given connection CID-x. In such embodiments, the MAC PDU 120 may be transported over the UL connection 316 identified by CID-x, and processed by the appropriate service flow.

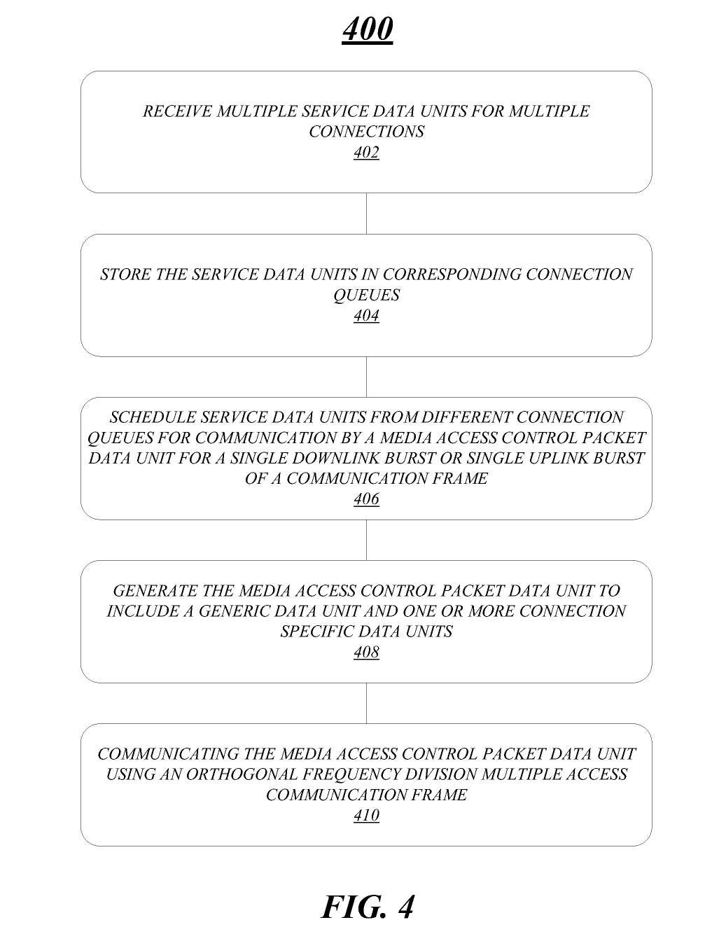

FIG. 4 illustrates one embodiment of a logic flow 400 for MAC header overhead reduction. In various embodiments, logic flow 400 may be performed by various systems and/or devices and may be implemented as hardware, software, and/or any combination thereof, as desired for a given set of design parameters. For example, logic flow 400 may be implemented by a logic device (e.g., computer) and/or logic (e.g., computer program instructions) to be executed by a logic device. For purposes of illustration, and not limitation, reference is made to FIGS. 1-3.

The logic flow 400 may receive multiple SDUs for multiple MAC layer connections at block 402. For example, the controller 200 may receive multiple SDUs 210 from various layers of a network protocol stack designated for various management or transport connections, such as CID1, CID2, and CID3.

The logic flow 400 may store the SDUs in corresponding connection queues at block 404. For example, the controller 200 may store the multiple SDUs 210 in the appropriate MAC connection queues 202-1-h. Referring again to FIG. 2, the MAC connection queues 202-1, 202-2 and 202-3 may be used to store respective k, m and n number of SDUs 210 waiting in their respective queues to be transmitted in a DL sub-frame from the BS 302 to the MS 304. The MAC connection queue 202-1 may have multiple SDU for the MAC connection CID1, as represented by SDU (1, 1), SDU (1, 2) and SDU (1, k). The MAC connection queue 202-2 may have multiple SDU for the MAC connection CID2, as represented by the SDU (2, 1), SDU (2, 2) and SDU (2, m). The MAC connection queue 202-3 may have multiple SDU for the MAC connection CID3, as represented by the SDU (3, 1), SDU (3, 2) and SDU (3, n).

The logic flow 400 may schedule SDUs from different connection queues for communication by a MAC PDU for a single DL burst or single UL burst of a communication frame at block 406. For example, the SDU scheduler 204 of the controller 220 may be operative to determine which MAC SDUs 210 of the different MAC connections for the MS 304 are to be transmitted in the DL sub-frame. As shown in FIG. 2, the SDU scheduler 204 schedules SDU (1, 1), SDU (1, 2), SDU (3, 1) to be transmitted in DL Burst 1 of DL sub-frame of frame j, and SDU (2, 1) to be transmitted in the DL Burst 2 of DL sub-frame of frame j.

The logic flow 400 may generate the MAC PDU to include a generic data unit and one or more connection specific data units at block 408. For example, the MAC PDU generator 206 may generate the MAC PDUs 120-1, 120-2. The MAC PDU 120-1 is generated containing SDU (1, 1), SDU (1, 2), and SDU (1, 3) since all these SDUs are to be transmitted in the same DL Burst 1 for the MS 304. The MAC PDU 120-2 is generated containing SDU (2, 1) to be transmitted in the DL Burst 2 for the same MS 304. The MAC PDUs 120-1, 120-2 may each have a packet data structure similar to the packet data structure 100, where the MAC PDUs 120-1, 120-2 each comprise a generic data unit 130 and one or more connection specific data units 140-1-c. The connection specific data units 140-1-c may each comprise a respective CMH 142-1-e and one or more SDUs for the appropriate connection.

The logic flow 400 may communicate the MAC PDU using an OFDMA communication frame at block 410. For example, the BS 302 may communicate the MAC PDU 120-1 in a DL Burst 1 of an OFDMA communication frame j, and the MAC PDU 120-2 in a DL Burst 2 of the OFDMA communication frame j or another OFDMA frame, to the MS 304.

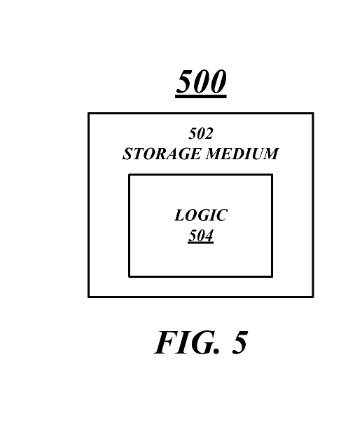

FIG. 5 illustrates one embodiment of an article of manufacture 500. As shown, article 500 may comprise a computer-readable storage medium 502 to store MAC controller logic 504. Examples of MAC controller logic 504 may include the logic appropriate for the controller 200. For example, the MAC controller logic 504 may comprise logic for the scheduler 204 to schedule SDUs from different connection queues for communication by a MAC PDU for a single downlink burst or single uplink burst of a communication frame in the respective downlink or uplink directions. In another example, the MAC controller logic 504 may comprise logic for the generator 206 to generate the MAC PDU to include a generic data unit and one or more connection specific data units. Article 500 may be implemented by various systems and/or devices in accordance with the described embodiments.

Article 500 and/or computer-readable storage medium 502 may include one or more types of computer-readable storage media capable of storing data, including volatile memory or, non-volatile memory, removable or non-removable memory, erasable or non-erasable memory, writeable or re-writeable memory, and so forth. Article 500 and/or computer-readable storage medium 502 may store MAC controller logic 504 comprising executable computer program instructions that, when executed by a computer, cause the computer to perform methods and/or operations in accordance with the described embodiments.

MAC controller logic 504 may comprise, or be implemented as, software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “one embodiment,” or “an embodiment” means that a particular feature, structure, or characteristic described in connection with the embodiment is included in at least one embodiment. Thus, appearances of the phrases “in various embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

Some embodiments may be implemented as an article of manufacture comprising a computer-readable storage medium to store executable computer program instructions for performing various operations as described herein. In such embodiments, a computer may include any suitable computer platform, device, system, or the like implemented using any suitable combination of hardware and/or software.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A method, comprising:
receiving multiple service data units for multiple connections;
storing the service data units in corresponding connection queues; and
scheduling service data units from different connection queues for communication by a media access control packet data unit for a single downlink burst or single uplink burst of a communication frame.

2. The method of claim 1, comprising generating the media access control packet data unit to include a generic data unit and one or more connection specific data units.

3. The method of claim 1, comprising generating a generic media access control header for the media access control packet data unit with a service data units for multiple connections field having a value indicating service data units for multiple media access layer connections are present or absent in the media access control packet data unit.

4. The method of claim 1, comprising appending one or more service data units for a first connection to a generic media access control header for the media access control packet data unit.

5. The method of claim 1, comprising generating a connection specific media access control header for the media access control packet data unit with connection information describing one or more service data units for a second connection.

6. The method of claim 1, comprising appending one or more service data units for a second connection to a connection specific media access control header for the media access control packet data unit.

7. The method of claim 1, comprising generating a connection specific media access control header for the media access control packet data unit with a service data units for multiple connections field having a value indicating one or more service data units for a subsequent connection follows one or more service data units for a current connection.

8. The method of claim 1, comprising generating a connection specific media access control header for the media access control packet data unit with a differential length encoding field having a value indicating whether a length value for a length field of the connection specific media access control header represents an actual length or an offset from a length value for a length field of a generic media access control header.

9. The method of claim 1, comprising generating a connection specific media access control header for the media access control packet data unit with a differential connection identifier field having a value representing a difference between a connection identifier for a current connection and a connection identifier for a preceding connection.

10. The method of claim 1, comprising generating a connection specific media access control header for the media access control packet with a length connection identifier encoding field having a value indicating a number of bits used to encode values for a length field and a differential connection identifier field of the connection specific media access control header.

11. The method of claim 1, comprising communicating the media access control packet data unit using an orthogonal frequency division multiple access communication frame.

12. An article comprising a machine-readable storage medium containing instructions that if executed enable a system to:
receive multiple service data units for multiple connections;
store the service data units in corresponding connection queues;
schedule service data units from different connection queues for communication by a media access control packet data unit for a single downlink burst or single uplink burst of a communication frame.

13. The article of claim 12, further comprising instructions that if executed enable the system to generate the media access control packet data unit to include a generic data unit and one or more connection specific data units.

14. The article of claim 12, further comprising instructions that if executed enable the system to generate a generic media access control header for the media access control packet data unit with a service data units for multiple connections field having a value indicating service data units for multiple media access layer connections are present or absent in the media access control packet data unit.

15. The article of claim 12, further comprising instructions that if executed enable the system to generate one or more connection specific media access control headers for the media access control packet data unit with connection information describing one or more service data units for various connections.

16. An apparatus, comprising:
a media access control controller comprising one or more components operative to establish a unidirectional logical link between a base station and a mobile station in either a downlink or uplink direction, the media access control controller having a service data unit scheduler operative to schedule service data units from different connection queues for communication by a single media access control packet data unit for a single downlink burst or single uplink burst of a communication frame in the respective downlink or uplink directions.

17. The apparatus of claim 16, the media access control controller to comprise a media access controller packet data unit generator operative to generate the media access control packet data unit to include a generic data unit and one or more connection specific data units.

18. The apparatus of claim 16, the media access control controller to comprise a media access controller packet data unit generator operative to generate a generic media access control header for the media access control packet data unit with a service data units for multiple connections field having a value indicating service data units for multiple media access layer connections are present or absent in the media access control packet data unit.

19. The apparatus of claim 16, the media access control controller to comprise a media access controller packet data unit generator operative to generate one or more connection specific media access control headers for the media access control packet data unit with connection information describing one or more service data units for various connections.

20. The apparatus of claim 16, comprising a radio to couple to the media access control controller, the radio operative to communicate the media access control packet data unit using an orthogonal frequency division multiple access communication frame.

21. A system comprising the apparatus of claim 20 coupled to an omni-directional antenna and a digital display.
